(19) United States
(12) Patent Application Publication
(10) Pub. No.: US 2010/0085915 A1
(43) Pub. Date: Apr. 8, 2010

(54) Overlay Network Node

(75) Inventors: Jun Hirano, Kanagawa (JP); Chan Wah Ng, Singapore (SG); Tien Ming Benjamin Koh, Singapore (SG); Mohana Dhamayanthi Jeyatharan, Singapore (SG); Pek Yew Tan, Singapore (SG)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/527,550

(22) PCT Filed: Feb. 26, 2008
(86) PCT No.: PCT/JP2008/000344

§ 371 Date: Aug. 17, 2009

(30) Foreign Application Priority Data
Feb. 27, 2007 (JP) 2007-048185

(51) Int. Cl. H04W 4/00; H04L 12/56; H04W 84/02

(52) U.S. Cl. 370/328; 370/392

(57) ABSTRACT

A technology is disclosed for actualizing route optimization on a network base, even when privacy-sensitive information, such as a position of a mobile node, is not revealed between two different networks. In the technology, a pHA 124 functions as a proxy home agent of a MN 130. When the pHA 124 receives a packet transmitted from the MN 130 (such as a packet destined for a MN 230), the pHA 124 transmits a query message inquiring about a current position to a home network 200 of the MN 230. In response to the query, a HA 220 gives notification of an address of a proxy home agent (pHA 224) in an overlay network to which the MN 230 is subscribing that is present nearest to the pHA 124. As a result, the pHA 124 sends the packet destined for the MN 230 to the pHA 224, and the packet is transmitted via the overlay network to which the MN 230 is subscribing.

### TECHNICAL FIELD

The present invention relates to an overlay network node that functions as a node in an overlay network that abstracts a packet exchange type data communication network, such as an internet protocol (IP) network.

### BACKGROUND ART

Many devices currently communicate with one another through use of internet protocol. Internet Engineering Task Force (IETF) prescribes mobility support in IPv6 to provide mobility support for mobile devices. Each mobile node has a permanent home domain in mobile IP. When a mobile node is connected to its home network, the mobile node is assigned a primary global address known as a home address (HoA). On the other hand, when the mobile node has moved away from the home network, namely when the mobile node is connected to another foreign network, the mobile node is ordinarily assigned a temporary global address known as a care-of address (CoA). The idea behind mobility support is to allow the mobile node to be reached at its home address even when the mobile node is connected to other foreign networks.

The above-described idea is put into practice in Non-patent Document 1, below, by an entity known as a home agent (HA) being introduced to the home network. The mobile node registers the care-of address to the home agent using a message known as a binding update (BU). As a result, the home agent can establish a binding between the home address and the care-of address of the mobile node. The home agent functions to intercept a message destined for the home address of the mobile node and transfer a packet to the care-of address of the mobile node using packet encapsulation (the packet becomes a payload of a new packet; also known as packet tunneling).

The above-described technology is a simple and accurate method of providing mobility support. However, packets transmitted and received by the mobile node are required to pass through the home agent. The packets flow through redundant paths, possibly causing delays in packet transmission.

As a method of solving this issue, use of a global home agent overlay network, described in Non-patent Document 2, below, is given. This method will be described with reference to FIG. 1A.

FIG. 1A is a diagram of an example of when an overlay network 110 is set in a global communication network 10, such as the Internet. The overlay network 110 includes a home agent 120, and proxy home agents (pHA) 122, 124, 126, and 128. A mobile node (MN) 130 is a mobile node moving within the global communication network 10. The home agent of the mobile node 130 is the HA 120. The home network of the mobile node 130 is a home network 100.

Here, it is assumed that the MN 130 is communicating with a correspondent node (CN) 30. Through use of mobile IPv6, a packet transmitted to the CN 30 from the MN 130 is encapsulated and is first sent to the HA 120 via a route 40. At this time, the HA 120 decapsulates the packet and transfers the actual data packet (inner packet) to the CN 30 via a route 42. Although a packet transmission route is dependent on relative positions of the MN 130 and the CN 30 to the HA 120, the packet transmission route becomes significantly longer than a shortest path between the MN 130 and the CN 30. Therefore, packet transmission is significantly delayed.

In the global home agent overlay network, a home agent and proxy home agent system is set on top of the global communication network 10. The mobile node that moves outside of the home network is assigned a proxy home agent located nearest to the mobile node. Then, in the overlay network, packets transmitted and received by the mobile node are transferred between two proxy home agents respectively located nearest to a transmission source (eg. mobile node) and a destination (eg. corresponding node with which the mobile node is communicating).

In the example shown in FIG. 1A, when the MN 130 is connected to an access network 14, the pHA 124 functions as the proxy home agent. In other words, binding update information and encapsulated data packets are transferred to the pHA 124 and processed by the pHA 124, instead of by the HA 120.

For example, when the MN 130 transmits a data packet to the CN 30, the MN 130 encapsulates the packet and transmits the encapsulated packet to the pHA 124 (route 50). After the pHA 124 decapsulates the packet, the pHA 124 determines that the destination (namely, the CN 30) is located nearest to the pHA 122 of the overlay network 110. The data packet is then transferred to the pHA 122 via a route 52. The transfer is, for example, performed via a tunnel between the pHA 122 and the pHA 124. The pHA 122 transfers the packet to the CN 30 via a route 54.

Through a comparison of routes (routes 40 and 42) not using the overlay network 110 and routes (routes 50, 52, and 54) using the overlay network 110, it is clear that a shorter packet transmission path can be actualized when the global home agent overlay network 110 is used. In this way, the overlay network 110 has an advantage in that ordinary mobile IPv6 route optimization is actualized without the mobile node or the correspondent node having to perform route optimization processes prescribed in Non-patent Document 1. Moreover, in the global home agent overlay network 110, the actual care-of address of the MN 130 is not revealed to the CN 130. The mobile node can keep its position private.

Like the global home agent overlay network 110, various types of overlay networks already exist. For example, in Patent Document 1, below, an overlay network configured by mobility anchor points (MAP) is described. Through use of the MAP overlay network, a mobile node moving outside of a MAP domain is assigned a new MAP by making a query to the MAP before movement. The MAP service is provided to the mobile node that has moved to a new position.

As described above, in the global home agent overlay network, the network transparently provides route optimization. Therefore, the mobile node and the correspondent node are not required to support a new function. Route optimization provided by the network side, such as this, can also be seen in conventional technologies described, for example, in Patent Documents 2 and 3, below.

In Patent Document 2, the actual position of a mobile node moving within a wireless local area network (LAN) or a third generation (3G) network is updated in a 3G1X system mobile switching center. Therefore, when the mobile switching center transmits a message to the mobile node, the mobile switching center can transmit the message directly to the actual position of the mobile node, rather than transmitting the message via the home network of the mobile node.

A method used in a mobile IPv4 environment is disclosed in Patent Document 3. In the method, the packet is transmitted directly to a foreign agent to which the mobile node is connected, instead of being transmitted via the home network of the mobile node. Such route optimization performed on a network base is advantageous in that the route optimization is transparently performed to some degree.

Patent Document 1: US Patent Application Publication No. 2006/0153136A1

Patent Document 2: US Patent Application Publication No. 2005/0276273A1

Patent Document 3: International Patent Publication No. WO2005/4523

Non-patent Document 1: Johnson, D. B., Perkins, C. E., Arkko, J., “Mobility Support in IPv6”, Internet Engineering Task Force Request For Comments 3775, June 2004

Non-patent Document 2: Thubert, P., et al., “Global HA to HA protocol”, Internet Draft: draft-thubert-nemo-global-haha-02.txt, Sep. 28, 2006

However, conventional route optimization performed on a network base requires co-operation between network entities in the global communication network 10. For example, in FIG. 1A, the co-operation between network entities is expressed by the global home agent overlay network 110. When the global communication network 10 is of the scale of the entire Internet, there are several thousand operators. It is extremely difficult for all operators to co-operate and form a single overlay network. Instead, formation of a plurality of overlay networks can be expected.

When a plurality of overlay networks are formed and two mobile nodes subscribing to different overlay networks communicate with each other, a problem related to route optimization occurs. This problem will be described with reference to FIG. 1B and FIG. 1C.

FIG. 1B is a diagram of an example of when two overlay networks 110 and 210 are set. The overlay network 110 includes a HA 120 related to a home network 100, a pHA 122 provided in an access network 12, a pHA 124 provided in an access network 14, a pHA 126 provided in an access network 16, and a pHA 128 provided in a home network 200.

On the other hand, the overlay network 210 includes a HA 220 related to the home network 200, a pHA 222 provided in the access network 12, a pHA 224 provided in the access network 14, a pHA 226 provided in the access network 16, and a pHA 228 provided in the home network 100.

A MN 130 is a subscriber to the overlay network 110 (can receive route-optimized packet transmission service in the overlay network 110). The home network of the MN 130 is the home network 100. A MN 230 is a subscriber of the overlay network 210 (can receive route-optimized packet transmission service in the overlay network 210). The home network of the MN 230 is the home network 200.

FIG. 1C is a diagram of a state in which the MN 130 and the MN 230 are communicating with each other in a configuration similar to that in FIG. 1B.

Here, it is assumed that the MN 130 transmits a packet to the MN 230. The MN 130 is present in the access network 14 and is assigned the pHA 124. Therefore, the packet transmitted by the MN 130 is transmitted to the pHA 124 via a route 60.

Based on the destination address (namely, the home address of the MN 230), the pHA 124 judges that the address is topologically located in the home network 200. The pHA 124 then transfers the packet to the proxy home agent PHA 128 provided in the home network 200 (route 62). Here, the pHA 128 transfers the packet within the home network 200. However, the MN 230 is not actually present in the home network 200. Therefore, the home agent 200 intercepts the packet (route 64) and tunnels the packet to the pHA 222 that is the proxy home agent assigned to the MN 230. As a result, the packet passes through a route 66 and is transferred from the pHA 222 to the MN 230 (route 68).

The packet routes 60, 62, 64, 66, and 68 in FIG. 1C clearly indicate that the packet is transmitted over a non-optimized route in the communication between two mobile nodes subscribing to different overlay networks. The route is not optimized even when each overlay network performs route optimization.

The easiest method of solving this issue is for information on the positions of the mobile nodes being exchanged between two different overlay networks. However, when this method is used, the position of the mobile node is required to be reported to another operator, causing privacy-related problems. Moreover, because route optimization is transparently provided in the overlay network, the mobile node has difficulty decided for itself whether to place importance on position privacy or route optimization.

### DISCLOSURE OF THE INVENTION

To solve the above-described issues, an object of the present invention is to allow route optimization on a network base to be actualized even when privacy-sensitive information, such as a position of a mobile node, is not revealed between two different networks.

To achieve the above-described object, an overlay network node of the present invention is an overlay network node belonging to an overlay network that is formed on top of a predetermined network and provides a global home agent overlay network service to a mobile node. The overlay network node includes a function related to the global home agent overlay network service. The overlay network node includes a proxy home agent executing means that functions as a proxy home agent of the mobile node receiving the global home agent overlay network service. The overlay network node also includes a packet receiving means for receiving a packet transmitted from the mobile node managed by the home agent executing means. The overlay network node also includes a node judging means for judging whether a node specified by a destination address of the packet is a mobile node. The overlay network node also includes an address query means for making a query to a node managing an address of the node specified by the destination address of the packet regarding a current address of the node specified by the destination address of the packet, when the node judging means judges that the node specified by the destination address of the packet is a mobile node. The overlay network node also includes an address acquiring means for acquiring an address of a node belonging to another global home agent overlay network as the current address of the node specified by the destination address of the packet, as a result of the query made by the address query means. The overlay network node also includes a packet transferring means for transferring the packet to the address acquired by the address acquiring means.

As a result of the configuration, route optimization can be actualized on a network base, even when privacy-sensitive information, such as a position of the mobile node, is not revealed between two different networks.

In addition to the above-described configuration, the overlay network node of the present invention includes a node judging means for judging whether the node specified by the destination address of the packet is a mobile node and, for instructing the address query means to make the query regarding the current address of the node when judging that the node specified by the destination address of the packet is a mobile node.

As a result of the configuration, route optimization based on the present invention can be started when one end node is detected to be a mobile node.

In addition to the above-described configuration, the overlay network node of the present invention includes a node identifying means for identifying an overlay network node belonging to a same overlay network as the overlay network to which the subject overlay network node belongs, the identified overlay network node being present nearest to the node belonging to the other global home agent overlay network acquired by the address acquiring means. The packet transferring means is arranged to tunnel the packet to the overlay network node identified by the node identifying means.

As a result of the configuration, route optimization can be actualized by the packet being tunneled to a node present near a node that is the communication partner.

In addition to the above-described configuration, the overlay network node of the present invention includes a query result storing means for storing a result of the query made by the address query means including the address of the node belonging to the other global home agent overlay network.

As a result of the configuration, address query results for actualizing route optimization can be cached.

In addition to the above-described configuration, the overlay network node of the present invention includes a cache-use controlling means for checking whether information corresponding to the destination address of the packet is stored in the query result storing means before the address query means makes the query. When usable information is stored in the query result storing means, the cache-use controlling means performs control to make the packet transferring means transfer the packet based on the information corresponding to the destination address of the packet stored in the query result storing means.

As a result of the configuration, route optimization can be actualized without a new query being made, through use of the cached address query results for actualizing route optimization.

To achieve the above-described object, an overlay network node of the present invention is an overlay network node belonging to an overlay network that is formed on top of a predetermined network and provides a global home agent overlay network service to a mobile node. The overlay network node includes a function related to the global home agent overlay network service. The overlay network node includes a home agent executing means for managing movement of the mobile node. The overlay network node also includes an address query receiving means for receiving a query regarding a current address of the mobile node of which the movement is managed by the home agent executing means, from a node belonging to another global home agent overlay network. The overlay network node also includes a node selecting means for selecting a node belonging to the overlay network providing the overlay network service to which the mobile node is subscribing, based on the query received by the address query receiving means. The overlay network node also includes a query responding means for giving notification of an address of the node selected by the node selecting means as the current address of the mobile node in response to the query.

As a result of the configuration, route optimization can be actualized on network base, even when privacy-sensitive information, such as a position of the mobile node, is not revealed between two different networks.

In addition to the above-described configuration, in the overlay network node of the present invention, the node selecting means is arranged to select a node belonging to the overlay network providing the overlay network service to which the mobile node is subscribing that is set in a position nearest to the node transmitting the query.

As a result of the configuration, route optimization is performed by a packet transmitted from one mobile node moving to another overlay network near a node functioning as a proxy home agent of the mobile node.

In addition to the above-described configuration, in the overlay network node of the present invention, the node selecting means is arranged to check whether a node belonging to the overlay network providing the overlay network service to which the mobile node is subscribing is present near the node transmitting the query.

As a result of the configuration, whether a suitable node is present near the node functioning as the proxy home agent of the mobile node transmitting the packet can be checked.

In addition to the above-described configuration, the overlay network node of the present invention includes a parameter notifying means for notifying the node transmitting the query of a parameter for setting a security association between the node selected by the node selecting means and the node transmitting the query.

As a result of the configuration, security protection of the transferred packet can be enhanced.

In addition to the above-described configuration, in the overlay network node of the present invention, the node selecting means is arranged to select a node belonging to the overlay network providing the overlay network service to which the mobile node is subscribing that is set in a position nearest to the mobile node.

As a result of the configuration, route optimization is performed by a packet transmitted from one mobile node moving to another overlay network near a mobile node that is the communication partner.

In addition to the above-described configuration, the overlay network node of the present invention includes a notifying means for notifying the node transmitting the query that the node selected by the node selecting means is no longer the node set in the position nearest to the mobile node, when a detection is made that the node selected by the node selecting means is no longer the node set in the position nearest to the mobile node.

As a result of the configuration, a change in the node at the position nearest to a mobile node accompanying movement of the mobile node can be determined.

In addition to the above-described configuration, in the overlay network node of the present invention, when the detection is made that the node selected by the node selecting means is no longer the node set in the position nearest to the mobile node, the node selecting means is arranged to re-select a node belonging to the overlay network providing the overlay network service to which the mobile node is subscribing that is set in a position nearest to the mobile node. The notifying means is arranged to notify the node transmitting the query of an address of the node newly selected by the node selecting means.

As a result of the configuration, a node at the position nearest to a mobile node that changes in accompaniment with the movement of the mobile node can remain a node suitable for route optimization.

In addition to the above-described configuration, in the overlay network node of the present invention, the node selecting means is arranged to select a node that is a node on a packet route between the node transmitting the query and the mobile node or a node positioned near the packet route, and that belongs to the overlay network providing the overlay network service to which the mobile node is subscribing.

As a result of the configuration, route optimization is performed by a packet transmitted from one mobile node moving to a different overlay network, to a node on (or near) a packet transmission route between a node functioning as the proxy home agent of the mobile node and a mobile node that is the communication partner.

In addition to the above-described configuration, in the overlay network node of the present invention, the node selecting means uses any one of methods in which: the node selecting means selects a node belonging to the overlay network providing the overlay network service to which the mobile node is subscribing that is set in a position nearest to the node transmitting the query; the node selecting means selects a node that is a node on a packet route between the node transmitting the query and the mobile node or a node positioned near the packet route, and that belongs to the overlay network providing the overlay network service to which the mobile node is subscribing; and the node selecting means selects a node belonging to the overlay network providing the overlay network service to which the mobile node is subscribing that is set in a position nearest to the mobile node.

As a result of the configuration, any one of a node near a node functioning as a proxy home agent of a mobile node transmitting a packet, a node on (or near) a packet transmission route between the node functioning as the proxy home agent of the mobile node transmitting the packet and the mobile node that is the communication partner, and a node near the mobile node that is the communication partner is selected.

In addition to the above-described configuration, in the overlay network node of the present invention, the node selecting means is arranged to select a node belonging to the overlay network providing the overlay network service to which the mobile node is subscribing that is set in a position nearest to the node transmitting the query. When the node set in the position nearest to the node transmitting the query cannot be identified, the node selecting means selects a node that is a node on a packet route between the node transmitting the query and the mobile node or a node positioned near the packet route, and that belongs to the overlay network providing the overlay network service to which the mobile node is subscribing. When the node on the packet route between the node transmitting the query and the mobile node or the node positioned near the packet route cannot be identified, the node selecting means selects a node belonging to the overlay network providing the overlay network service to which the mobile node is subscribing that is set in a position nearest to the mobile node.

As a result of the configuration, the degree to which privacy, such as that regarding a position of a mobile node, is protected can be taken into account through selection being made in the order of a node near a node functioning as a proxy home agent of a mobile node transmitting a packet, a node on (or near) a packet transmission route between the node functioning as the proxy home agent of the mobile node transmitting the packet and the mobile node that is the communication partner, and a node near the mobile node that is the communication partner.

The present invention has the above-described configuration. The present invention achieves an effect in which route optimization is actualized on a network base, even when privacy-sensitive information, such as a position of the mobile node, is not revealed between two different networks.

### BRIEF DESCRIPTION OF THE DRAWINGS

FIG. 1A is a diagram of an example of a packet transmission route when a single overlay network is present in a network configuration of a conventional technology;

FIG. 1B is a diagram of an example of a configuration in which a plurality of overlay networks are present in a network configuration of a conventional technology;

FIG. 1C is a diagram of an example of a packet transmission route when a plurality of overlay networks are present in a network configuration of a conventional technology;

FIG. 2 is a diagram of an example of a packet transmission route when a plurality of overlay networks are present in a network configuration according to a first embodiment of the present invention;

FIG. 3A is a diagram of an example of a packet transmission route when a plurality of overlay networks are present in a network configuration according to a second embodiment of the present invention;

FIG. 3B is a diagram of an example of changes in the packet transmission route when one communication end node (MN 230) moves in the configuration shown in FIG. 3A;

FIG. 4 is a diagram of an example of a packet transmission route when a plurality of overlay networks are present in a network configuration according to a third embodiment of the present invention;

FIG. 5 is a diagram of an example of a configuration of a home agent or a proxy home agent according to the first to third embodiments of the present invention;

FIG. 6 is a flowchart of an example of an operation of the proxy home agent according to the first to third embodiments of the present invention; and

FIG. 7 is a flowchart of an example of an operation of the home agent according to the first to third embodiments of the present invention;

### BEST MODE FOR CARRYING OUT THE INVENTION

Embodiments of the present invention will hereinafter be described with reference to the drawings. First to third embodiments of the present invention will be described below. According to all embodiments, route optimization is performed among a plurality of overlay networks when communication is performed between two mobile nodes.

### First Embodiment

According to a first embodiment of the present invention, when a first mobile node (subscribing to a first overlay network) transmits a packet to a second mobile node (subscribing to a second overlay network), the first overlay network communicates with the second overlay network and makes a query regarding a physical position of the second mobile node.

The second overlay network does not respond with the actual position (care-of address) of the second mobile node, so as not to reveal the actual position of the second mobile node. Instead, the second overlay network responds with an address of a proxy home agent within the second overlay network present nearest to the query node (the node making the query). As a result, the first overlay network sends the packet destined for the second mobile node to the address of the nearest proxy home agent.

Then, the nearest proxy home agent sends the received packet directly to the second mobile node, via second overlay network resources. As a result, route optimization can be actualized in communication between two mobile nodes without privacy-sensitive information related to the position of the second mobile node being leaked to other operators (other overlay networks).

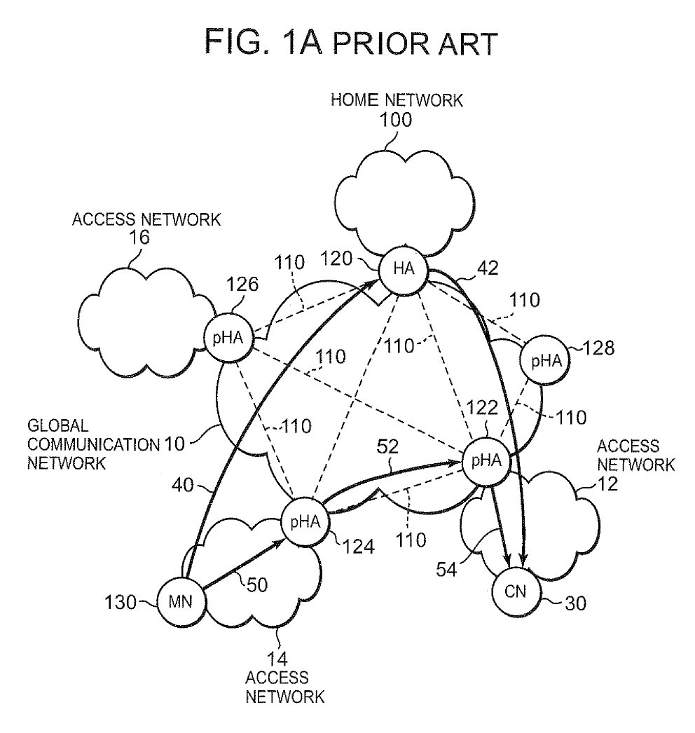

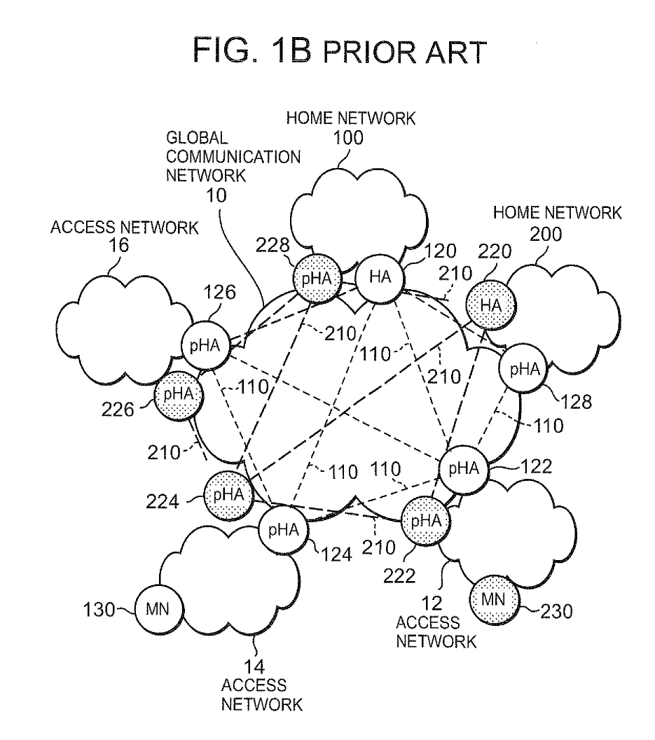

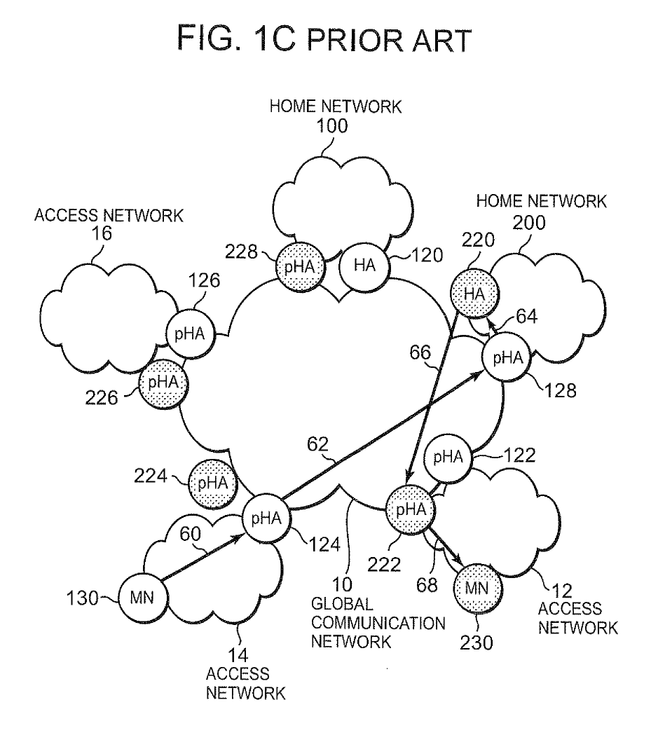

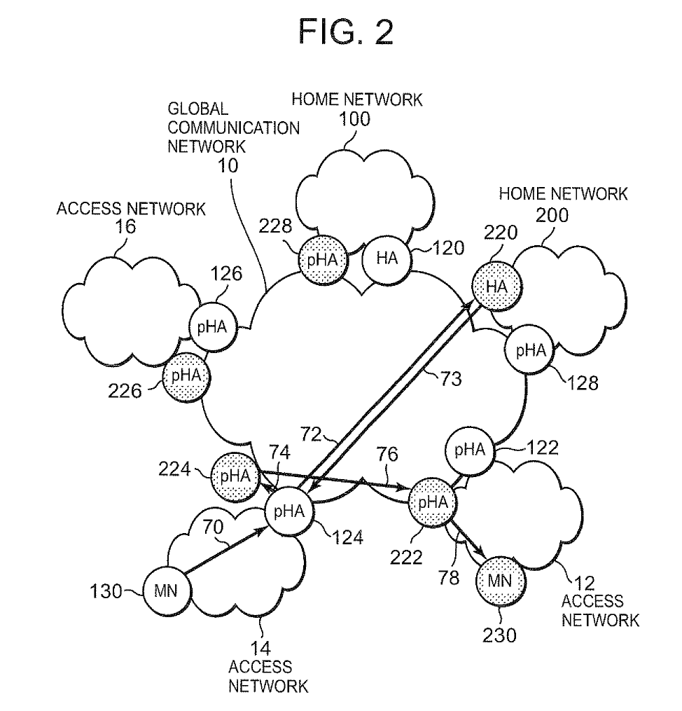

FIG. 2 is a diagram of an example of a network configuration and a packet transmission route according to the first embodiment of the present invention. In FIG. 2, a configuration shown in FIG. 1B is used in which two overlay networks are set.

When the MN 130 is connected to the access network 14, the pHA 124 functions as the proxy home agent of the MN 130. When the MN 130 is attempting to transmit a packet to the MN 230, first, as indicated by a route 70, the MN 130 encapsulates the packet towards the pHA 124. When the pHA 124 receives the packet, the pHA 124 determines that the destination address is that of a mobile node.

An arbitrary method can be used as the method by which the pHA 124 determines that the destination of the packet is the mobile node. For example, the mobile node subscribing to the overlay network is preferably given a home address having a specific bit pattern allowing identification as the mobile node. Alternatively, the pHA 124 can simply assume that the destination address is that of a mobile node and attempt communication with the home agent of the destination address. In this instance, when the communication with the home agent cannot be performed, the pHA 124 concludes that the destination address is not that of a mobile node. The pHA 124 preferably caches pieces of information such as this. When the pHA 124 subsequently receives a packet addressed to the same destination address, the pHA 124 determines whether the destination address is that of a mobile node based on the cache.

When the destination address of the packet is not that of a mobile node, an ordinary packet transfer method is used in which the packet is transferred to a proxy home agent in the overlay network 110 nearest to the destination address. This is an ordinary operation of the overlay network disclosed by conventional technology. Hereafter, an instance related to the present invention (namely, when the destination address is determined to be that of a mobile node) will be described.

When the destination address of the packet is the mobile node, the pHA 124 transmits a query message 72 inquiring about the position of the MN 230 to the home network of the destination. In the example shown in FIG. 2, the destination node is the MN 230, and the home network of the MN 230 is the home network 200.

The HA 220 in the home network 200 receives the query message 72 and returns a response message 73. The MN 230 wishes to keep its position private. Therefore, the actual position of the MN 230 is not included in the response message 73. Instead, a transfer destination address judged suitable by the HA 220 is included. For example, the response message 73 includes an address of a proxy home agent in the overlay network 210 present nearest to the pHA 124. In the example shown in FIG. 2, the nearest proxy home agent is the pHA 224.

When the pHA 124 receives the response message 73, the pHA 124 determines that the suitable transfer destination to the MN 230 is the pHA 224. Because the pHA 224 is positioned near the access network 14, the pHA 124 is not required to transmit the packet via the overlay network 110 to optimize the route. Instead, the pHA 124 simply decapsulates the packet from the MN 130 and transmits the decapsulated packet (inner packet) towards the pHA 224. In FIG. 2, the transmission of the decapsulated packet is indicated by a route 74.

When the pHA 224 receives the packet, the pHA 224 notices that the destination address is that of the subscribing mobile node 230. Because the pHA 224 is a member of the overlay network 210, the pHA 224 can determine the actual position (such as the care-of address) of the MN 230 subscribing to the overlay network 210. The pHA 224 then determines that the pHA 222 is the proxy home agent nearest to the MN 230 in the overlay network 210. As a result, the packet is transferred to the pHA 222 via the overlay network 210, as indicated by a route 76. When the pHA 222 receives the packet, the pHA 222 transfers the packet to the care-of address of the MN 230, as indicated by a route 78.

As described above, route optimization can be actualized in the communication between the MN 130 and the MN 230 through use of the above-described method according to the first embodiment of the present invention, even when, for example, two mobile nodes (the MN 130 and the MN 230) subscribe to different overlay networks and the location privacy of the mobile nodes is protected.

As a result of the pHA 124 caching the address of the pHA 224 as the care-of address of the MN 230, the pHA 124 is not required to re-transmit the query message 72 even when packets are subsequently transmitted from the MN 130 (or another subscribing mobile node) to the MN 230.

According to the above-described first embodiment of the present invention, the operation is performed when the distance between the pHA 124 and the pHA 224 is as short as possible (preferably a single hop). This set-up is ordinarily possible in a typical network configuration in, for example, a third generation mobile communication network.

The home networks 100 and 200 are ordinarily universal mobile telecommunications system (UMTS) core networks. The access networks 12, 14, and 16 are ordinarily wireless LAN networks. Therefore, each mobile operator sets a packet distribution gateway (PDG) in the access network. A PDG such as this can function as a proxy home agent in an overlay network. In a configuration such as this, PDG belonging to different mobile operators are ordinarily set in positions that are a single hop away from one another.

Therefore, an overall length of the routes 70, 74, 76, and 78 shown in FIG. 2 is ordinarily significantly shorter than an overall length of the routes 60, 62, 64, 66, and 68 shown in FIG. 1C. Route optimization is achieved.

Here, it is important that the pHA 124 is able to transfer a packet having the home address of the MN 130 as the transmission source address and the home address of the MN 230 as the destination address. When the pHA 224 and the pHA 124 are only separated by a single hop, packet transfer can ordinarily be performed. However, when an intermediate router is present between the pHA 124 and the pHA 224, phenomena such as those below may occur.

First, because the destination address of the packet is the home address of the MN 230, the intermediate router may transmit the packet to a position away from the pHA 224 (towards the home network 200). Second, the intermediate router may perform an operation, such as ingress filtering. In this instance, the packet may be discarded because the transmission source address of the packet is the home address of the MN 130 (an invalid address in terms of topology near the access network 14).

The first phenomenon in which the packet is transmitted to a position away from the pHA 224 can be countered by the pHA 224 setting a route to a nearby router, and the routers transmitting the packet destined to the home network 200 to the pHA 224. In this countermeasure, the pHA 224 is required to be capable of setting a route such as that described above.

The second phenomenon caused by ingress filtering and the like can be countered by the pHA 124 tunneling the packet to the pHA 224. However, in this operation, a security association is not established between the pHA 124 and the pHA 224 in advance. Therefore, security measures may be required. In this instance, when the pHA 124 transmits the query message 72 to the HA 220, the HA 220 can set the security association between the pHA 124 and the pHA 224, and give notification by the response message 73 that the security association has been set.

### Second Embodiment

On the other hand, according to a second embodiment of the present invention, the above-described first and second phenomena related to packet transfer between pHA in different overlay networks are countered through protection of privacy of positions being sacrificed to a certain degree.

According to the second embodiment of the present invention, when a first mobile node (subscribing to a first overlay network) transmits a packet to a second mobile node (subscribing to a second overlay network), the first overlay network communicates with the second overlay network and makes a query regarding a physical position of the second mobile node.

To provide route optimization without occurrence of a phenomenon related to setting of a route that transfers the packet to a certain pHA with certainty and a phenomenon related to ingress filtering, the second overlay network responds with an address of a proxy home agent within the second overlay network (a proxy home agent nearest to the second mobile node). As a result, the first overlay network can send the packet to the above-described proxy home agent present within the second overlay network and nearest to the second mobile node. In this instance, the packet can be sent to the proxy home agent nearest to the second mobile node after the packet is sent to the proxy home agent within the first overlay network present near the proxy home agent nearest to the second mobile node.

The proxy home agent nearest to the second mobile node can send the packet directly to the second mobile node subscribing to the second overlay network. As a result, route optimization is actualized in the communication between the two mobile nodes. In the above-described operation, privacy of the position of the second mobile node is minimally protected. Minimal protection indicates that, while only an approximate position (such as the access network in which the second mobile node is present) of the care-of address of the second mobile node is revealed, the actual care-of address of the second mobile node is not revealed.

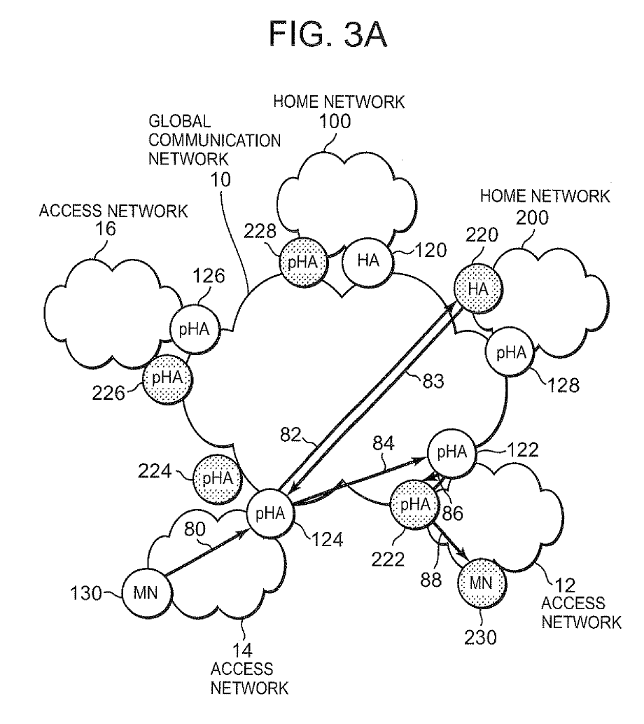

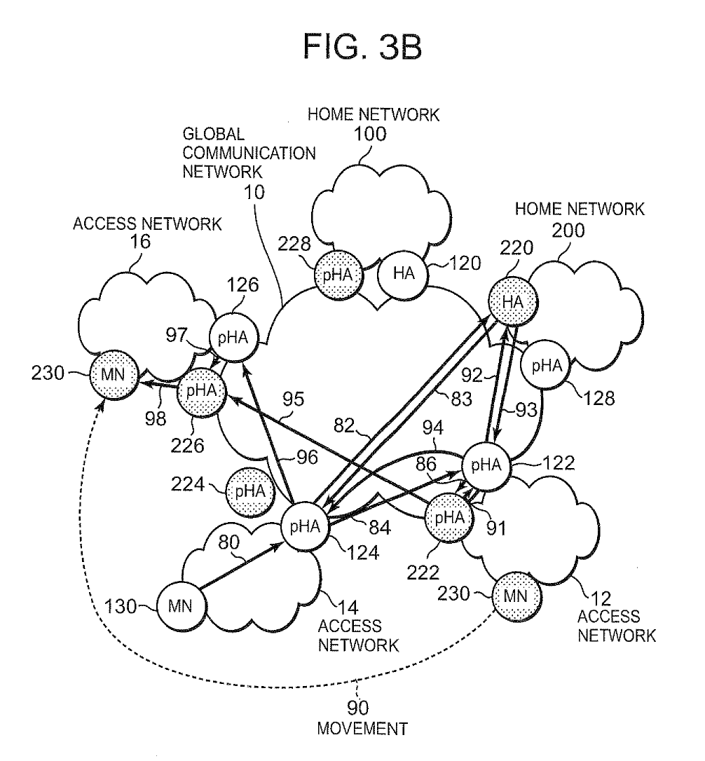

FIG. 3A is a diagram of an example of a network configuration and a packet transmission route according to the second embodiment of the present invention. In FIG. 3A, the configuration shown in FIG. 1B is used in which two overlay networks are set.

In FIG. 3A, when the MN 130 is connected to the access network 14, the pHA 124 functions as the proxy home agent. When the MN 130 attempts to transmit the packet to the MN 230, first, as indicated by a route 80, the MN 130 encapsulates the packet towards the pHA 124. When the pHA 124 receives the packet, the pHA 124 determines that the destination address is that of a mobile node. In a manner similar to that according to the above-described first embodiment of the present invention, the method by which the pHA 124 determines that the destination address is that of a mobile node is arbitrary.

The pHA 124 transmits a query message 82 to the home network of the destination of the received packet. In FIG. 3A, the destination node is the MN 230. The home network of the MN 230 is the home network 200. The HA 220 in the home network 200 receives the query message 82 and returns a response message 83.

Here, it is assumed that the HA 220 has determined that the first embodiment of the present invention does not work regarding a predetermined transmission source address (namely, the address of the pHA 124) of the query message 82. The HA 220 may determine the above from, for example, the proxy home agent not being able to set a route near the pHA 124, the security association not being able to be established (or not being desired) between the proxy home agent in the overlay network 210 and the overlay network 110, or some other reason. A method by which the HA 220 determines that the first embodiment of the present invention does not work is not limited to the above-described methods.

At this time, the response message 83 includes an address of the proxy home agent in the overlay network 210 nearest to the MN 230. In the example shown in FIG. 3A, the nearest proxy home agent is the pHA 222.

When the pHA 124 receives the response message 83, the pHA 124 determines that the suitable transfer destination for the MN 230 is the address of the pHA 222. The pHA 124 then transfers the packet via the overlay network 110 to optimize the route. In the example shown in FIG. 3, the pHA 122 is nearest to the pHA 222 in the overlay network 110. Therefore, as indicated by a route 84, the pHA 124 tunnels the packet to the pHA 122. The pHA 122 then decapsulates the packet and transfers the decapsulated packet (inner packet) to the pHA 222 (as indicated by a route 86 in FIG. 3A).

When the pHA 222 receives the packet, the pHA 222 determines that the destination is the MN 230 subscribing to the overlay network 210 and the current position of the MN 230 is actually the access network 12 (managed by the pHA 222 itself). As a result, the pHA 222 tunnels the packet to the care-of address of the MN 230, as indicated by a route 88.

As described above, route optimization can be actualized in the communication between the MN 130 and the MN 230 through use of the method described according to the second embodiment of the present invention, even when the two mobile nodes subscribe to different overlay networks and privacy of the positions of the mobile nodes is minimally protected.

As a result of the pHA 124 caching the address of the pHA 222 (or the address of the pHA 122) as the care-of address of the MN 230, the PHA 124 is not required to re-transmit the query message 82 even when packets are subsequently transmitted from the MN 130 (or another subscribing mobile node) to the MN 230.

Compared to the first embodiment of the present invention, the second embodiment of the present invention has an advantage in that the amount of resources of the overlay network 210 used can be reduced. When FIG. 2 and FIG. 3A are compared, it is clear that, while two pHA of the overlay network 210 are used in the transmission of the packet transmitted from the mobile node that is a subscriber of the overlay network 110 according to the first embodiment of the present invention, only one pHA of the overlay network 210 is used according to the second embodiment of the present invention.

According to the first embodiment of the present invention, the address provided to the overlay network 110 is the address of the proxy home agent (pHA 224) nearest to the pHA 124. Because the pHA 224 remains the nearest proxy home agent to the pHA 124 even when the MN 230 moves (is not dependent on the location of the MN 230), the operation of the overlay network 110 is not affected.

On the other hand, according to the second embodiment of the present invention, the address provided to the overlay network 110 is the address of the proxy home agent (pHA 222) nearest to the MN 230. Therefore, the nearest proxy home agent changes when the MN 230 moves. As a result, according to the second embodiment of the present invention, signaling is required to be performed again with movement of the MN 230.

The above-described issue will be described with reference to FIG. 3B. In FIG. 3B, as indicated by a movement 90, the MN 230 moves from the access network 12 to the access network 16. As a result, the assigned proxy home agent changes from the pHA 222 to the pHA 226.

Here, it is assumed that the MN 130 continues to transmit a packet to the MN 230. In a manner similar to that in the above-described example, the packet is transmitted over the route 80 to the pHA 124. The pHA 124 that caches the suitable transfer destination to the MN 230 tunnels the packet to the pHA 122 via the overlay network 110, as indicated by a route 84. The pHA 122 then transfers the packet to the pHA 222 as indicated by a route 86. The above-described operation is the same as the operation shown in FIG. 3A, described above. However, as described above, the MN 230 has already moved and is not present in the access network 12. Therefore, the packet does not reach the MN 230.

Under normal circumstances, the pHA 222 intercepts the packet and tunnels the packet to the correct proxy home agent (pHA 226) via the overlay network 210, as indicated by a route 95. However, this packet transmission route is a detour. Therefore, for example, when the pHA 222 detects that the packet transmission source pHA 122 belongs to another overlay network, the pHA 222 can transmit an error message to the packet transmission source pHA 122. When the error message is received, the overlay network 110 preferably makes another query regarding the position of the MN 230.

Numerous methods exist by which the pHA 222 determines that the packet transmission source belongs to another overlay network. For example, a favorable method is through checking of the transmission source address of the packet. When the transmission source address is that of a mobile node and does not belong near the pHA 222, the packet may have been transferred by the overlay network.

The error message is transmitted to a layer 2 address of the packet transmission source. As a result, as indicated by a route 91 in FIG. 3B, the error message reaches the pHA 122 from the pHA 222. Several methods exist by which the pHA 122 performs correction after receiving the error message. For example, a favorable method is that in which the pHA 122 gives notification of the error to the pHA 124, as indicated by a route 94. The error notification serves as a trigger by which the pHA 124 retransmits the query message 82 to the HA 220.

The response message 83 from the HA 220 can include an address of the pHA 226 depending on the movement 90 of the MN 230. The pHA 124 tunnels subsequent packets transmitted from the MN 120 to the MN 230 to the pHA 126 as indicated by a route 96. As a result, the pHA 126 can transfer the packet to the pHA 226 (route 97). Ultimately, the pHA 126 can transfer the packet to the MN 230 as indicated by a route 98.

Moreover, the pHA 122 can transmit a query message 92 to the HA 220. A response message 93 transmitted from the HA 220 in response to the query message 92 includes the address of the pHA 226. The pHA 122 transmits an error message including the address of the new proxy home agent of the MN 230 (the address of the pHA 226) to the pHA 124.

Then, the pHA 124 tunnels subsequent packets transmitted from the MN 130 to the MN 230 to the pHA 126 as indicated by the route 96. The pHA 126 can transfer the packet to the pHA 226 (route 97). Ultimately, the pHA 226 can transfer the packet to the MN 230 as indicated by the route 98.

As another example according to the second embodiment of the present invention, the pHA 222 can notify the pHA 122 of the address of the pHA 226 by the error message. As a result, the overlay network 110 is immediately notified of the address of the new proxy home agent of the MN 230. Either of the pHA 122 and the pHA 124 is not required to transmit the query messages 82 and 92 to the HA 22. This works when the pHA 222 has determined the actual position of the MN 230. In the overlay network, all agents within the overlay network are notified of the actual positions of the subscribing mobile nodes. Therefore, it is highly possible that the pHA 222 can determine the actual position of the MN 230.

In a manner similar to that according to the first embodiment of the present invention, the above-described second embodiment of the present invention can work when the distance between the pHA 124 and the pHA 224 is as short as possible (preferably a single hop). The home networks 100 and 200 are ordinarily UMTS core networks. The access networks 12, 14, and 16 are ordinarily wireless LAN networks. Therefore, each mobile operator sets a packet distribution gateway (PDG) in the access network. A PDG such as this can function as a proxy home agent in an overlay network. In a configuration such as this, PDG belonging to different mobile operators are ordinarily set in positions that are a single hop away from one another.

Therefore, an overall length of the routes 80, 84, 86, and 88 shown in FIG. 3A (or an overall length of the routes 80, 96, 97, and 98 shown in FIG. 3B) is ordinarily significantly shorter than an overall length of the routes 60, 62, 64, 66, and 68 shown in FIG. 1C. Route optimization is achieved.

### Third Embodiment

The first embodiment of the present invention has an advantage in that protection of privacy of positions is enhanced and signaling is not required to be performed again even when the destination mobile node (namely, the MN 230) moves. On the other hand, the second embodiment of the present invention has an advantage in that measures regarding ingress filtering and route setting near the pHA 124, and the like can be avoided. As a result of the above-described first embodiment and second embodiment of the present invention being combined, respective advantages of the first embodiment and the second embodiment of the present invention can be efficiently actualized. According to a third embodiment of the present invention, when the first embodiment and the second embodiment of the present invention are combined will be described below.

According to the third embodiment of the present invention, as long as the MN 230 does not move over a long distance, the methods described according to the first embodiment of the present invention can be used as measures against ingress filtering and route setting near the pHA 124, and the like.

According to the third embodiment of the present invention, when the first mobile node (subscribing to the first overlay network) transmits a packet to the second mobile node (subscribing to the second overlay network), the first overlay network communicates with the second overlay network and makes a query regarding a physical position of the second mobile node.

To provide route optimization without occurrence of phenomena related to route setting and ingress filtering, the second overlay network responds with an address of a proxy home agent within the second overlay network (a proxy home agent along a path from the first mobile node to the second mobile node or a proxy home agent present near the path). As a result, the first overlay network can send the packet to the proxy home agent belonging to the second overlay network that is present on the path from the first mobile node to the second mobile node or near the path. The proxy home agent on the path sends the packet to the second mobile node using the second overlay network. As a result, route optimization is achieved in the communication between two mobile nodes.

As described above, according to the third embodiment of the present invention, privacy of the position of the second mobile node is protected to a certain degree. Protection to a certain degree indicates that, while only an approximate direction in which the second mobile node is present is revealed, the actual care-of address of the second mobile node is not revealed.

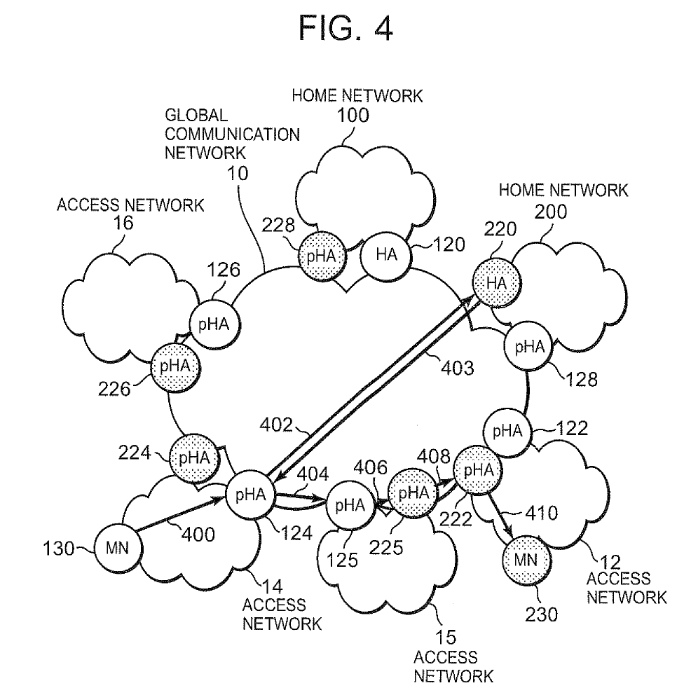

FIG. 4 is a diagram of an example of a network configuration and a packet transmission route according to the third embodiment of the present invention. In FIG. 4, in addition to the configuration shown in FIG. 1B in which two overlay networks are set, a configuration is used in which an access network 15 is further present. The access network 15 is positioned between the access network 14 and the access network 12. A proxy home agent 125 of the access network 15 is present in the overlay network 110. A proxy home agent 225 of the access network 15 is present in the overlay network 210.

In FIG. 4, when the MN 130 is connected to the access network 14, the pHA 124 functions as the proxy home agent. When the MN 130 attempts to transmit a packet to the MN 230, first, as indicated by a route 400, the MN 130 encapsulates the packet towards the pHA 124. When the pHA 124 receives the packet, the pHA 124 determines that the destination address is that of a mobile node. In a manner similar to that according to the first embodiment of the present invention, the method by which the pHA 124 determines that the destination address is that of a mobile node is arbitrary.

The pHA 124 transmits a query message 402 to the home network of the destination. In FIG. 4, the destination node is the MN 230. The home network is the home network 200. The HA 220 of the home network 200 receives the query message 402 and returns a response message 403.

Here, it is assumed that the HA 220 has determined that the first embodiment of the present invention does not work regarding a predetermined transmission source address (namely, the address of the pHA 124) of the query message 402. The HA 220 may determine the above from, for example, the proxy home agent not being able to set a route near the pHA 124, the security association not being able to be established (or not being desired) between the proxy home agent in the overlay network 210 and the overlay network 110, or some other reason. A method by which the HA 220 determines that the first embodiment of the present invention does not work is not limited to the above-described methods.

Moreover, the HA 220 can determine the position of the pHA 225 present between the pHA 124 and the MN 230. The HA 220 inserts the address of the pHA 225 in the response message 403. The HA 220 can select an arbitrary proxy home agent that belongs to the second overlay network, and is present on the path between the pHA 124 and the MN 230 or near the path.

When the pHA 124 receives the response message 403, the pHA 124 determines that the suitable transfer destination to the MN 230 is the address of the pHA 225. The pHA 124 then transfers the packet via the overlay network 110 to optimize the route. In the example shown in FIG. 4, the pHA 125 is nearest to the pHA 225 in the overlay network 110. Therefore, as indicated by a route 404, the pHA 124 tunnels the packet to the pHA 125. The pHA 125 then decapsulates the packet and transfers the decapsulated packet (inner packet) to the pHA 225 (as indicated by a route 406 in FIG. 4).

When the pHA 225 receives the packet, the pHA 225 notices that the destination is the subscribing mobile node 230, and its current position is actually the access network 12 (managed by the pHA 222). As a result, as indicated by a route 408, the pHA 225 transfers the packet to the pHA 222 using the overlay network 210. Ultimately, the pHA 222 that is the home agent assigned to the MN 230 tunnels the packet to the care-of address of the MN 230, as indicated by a route 410.

As described above, route optimization can be actualized in the communication between the MN 130 and the MN 230 through use of the method described according to the third embodiment of the present invention, even when the two mobile nodes subscribe to different overlay networks and privacy of the positions of the mobile nodes is protected to a certain degree.

As a result of the pHA 124 caching the address of the pHA 225 (or the address of the pHA 125) as the care-of address of the MN 230, the pHA 124 is not required to re-transmit the query message 402 even when packets are subsequently transmitted from the MN 130 (or another subscribing mobile node) to the MN 230.

In a manner similar to that according to the first and second embodiments of the present invention, the above-described third embodiment of the present invention can work when the distance between the pHA 125 and the pHA 225 is as short as possible (preferably a single hop). The home networks 100 and 200 are ordinarily UMTS core networks. The access networks 12, 14, 15, and 16 are ordinarily wireless LAN networks. Therefore, each mobile operator sets a packet distribution gateway (PDG) in the access network. A PDG such as this can function as a proxy home agent in an overlay network. In a configuration such as this, PDG belonging to different mobile operators are ordinarily set in positions that are a single hop away from one another.

Therefore, an overall length of the routes 400, 404, 406, 408, and 410 shown in FIG. 4 is ordinarily significantly shorter than an overall length of the routes 60, 62, 64, 66, and 68 shown in FIG. 10. Route optimization is achieved. Moreover, even when the MN 230 moves and the access network changes, the pHA 225 is most likely present along a path from the pHA 124 to the new position of the MN 230. Therefore, according to the third embodiment, signaling is less often required to be performed again when the MN 230 moves.

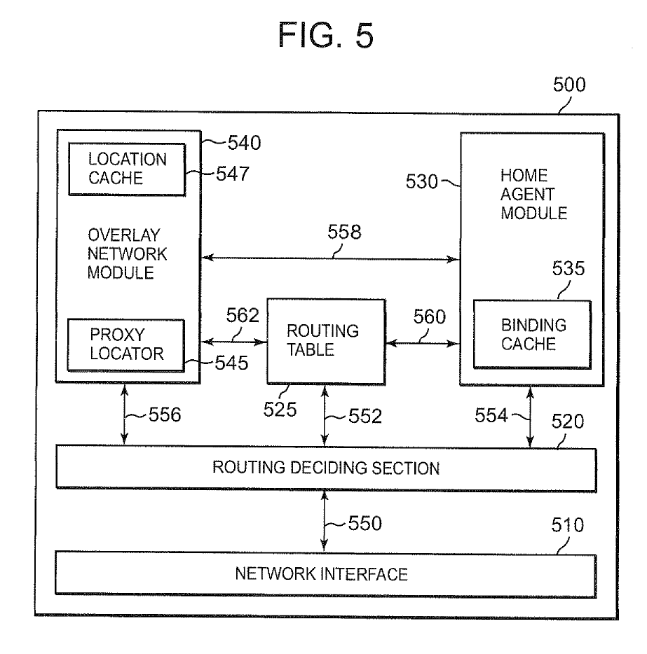

Next, a configuration and operations of a node belonging to the overlay network used according to the first to third embodiments of the present invention will be described. FIG. 5 is a diagram of a suitable functional architecture 500 of the node in the overlay network. The functional architecture 500 mainly functions as a home agent or a proxy home agent.

The functional architecture 500 includes a single network interface 510 or a plurality of network interfaces 510 for transmitting and receiving packets, a routing deciding section 520 that decides packet transmission and transfer methods, a routing table 525 that includes pieces of information related to the packet transmission and transfer methods, a home agent module 530 providing a mobile node with a home agent function, and an overlay network module 540 that functions to actualize route optimization related to a mobile node within the overlay network.

The network interface 510 is a functional block including all pieces of hardware and software required for a node to communicate with another node through a communication medium. When terminology known in the related technical field are used, the network interface 510 indicates a layer 1 (physical layer) and layer 2 (data link layer) communication components, firmware, a driver, and a communication protocol. The functional architecture 500 has one or more network interfaces 510.

The routing deciding section 520 performs a deciding process regarding the packet transmission method. When terminology known in the related technical field is used, the routing deciding section 520 indicates, for example, implementation of a layer 3 (network layer) protocol, such as internet protocol version 4 or version 6 (IPv4 or IPv6).

The routing table 525 includes rules prescribing packet routing to support the deciding process performed by the routing deciding section 520. The routing table 525 preferably includes a list of routing entries. An address of a node at a next hop, for example, is written in each routing entry. Alternatively, the network interface 510 to which the packet is sent is written based on a destination address, a transmission source address, and other pieces of information obtained from the packet to be transmitted. The next transfer destination of the packet is decided based on these pieces of information.

The routing deciding section 520 can update an entry in the routing table 525 and extract an entry form the routing table 525 via a signal/data path 552. Moreover, the routing deciding section 520 can transmit and receives packets through a suitable network interface 510, via a signal/data path 550.

The home agent module 530 actualizes a function of a home agent for supporting a mobile node. The home agent module 530 provides functions of intercepting a packet transmitted to the mobile node, transferring a packet destined to the mobile node or a packet transmitted from the mobile node, managing mobility of the mobile node, and the like. For example, the home agent module 530 provides a function prescribed in mobile IPv4, mobile IPv6, and/or network mobility (NEMO) support.

The home agent module 530 also includes a binding cache 535 for storing mapping of the home address and the care-of address (actual position) of the mobile node. A packet can be exchanged between the routing deciding section 520 and the home agent module 530 via a signal path 554.

The home agent module 530 can update and retrieve pieces of routing information stored in the routing table 525, via a signal path 560. For example, when the home agent module 530 can successfully process a binding update message from a mobile router, the home agent module 530 may be required to write the new route into the routing table 525. At this time, the routing table 525 is updated such that a packet addressed to a mobile network prefix managed by the mobile router is sent to the care-of address of the mobile router through a runnel interface.

The overlay network module 540 provides a function for allowing the node including the functional architecture 500 to operate as a member of the overlay network. The overlay network module 540 also provides a function prescribed, for example, by global HA-HA protocol (refer to Non-patent Document 1).

A proxy locator 545 that is a sub-module of the overlay network module 540 provides a function for determining a suitable proxy within the overlay network form the destination address of the packet. The proxy locator 545 can be implemented simply as an information database. Alternatively, the proxy locator 545 can perform logic processing required for a query to be made to an external entity regarding a position of a proxy.

A location cache 547 within the overlay network module 540 provides a function for storing an actual position (or a suitable transfer destination) of the mobile node. For example, as according to the above-described preferred embodiments of the present invention, the location cache 547 is used to store a received response message when a query is made to an external home agent regarding an actual position (or a suitable transfer destination) of the mobile node.

Packets can be exchanged between the overlay network module 540 and the routing deciding section 520 via a signal path 556. The overlay network module 540 can update and retrieve pieces of routing information stored in the routing table 525, via a signal path 562. For example, the overlay network module 540 may be required to insert a route into the routing table 525 such that a packet transmitted towards an arbitrary destination is transmitted to a specific proxy within an overlay network specified by the proxy locator 545.

The overlay network module 540 and the home agent module 530 can communicate with each other and exchange information via a signal path 558. For example, when a mobile node is registered (binding update), the home agent module 530 is required to spread registration information on the mobile node throughout the overall overlay network via the overlay network module 540.

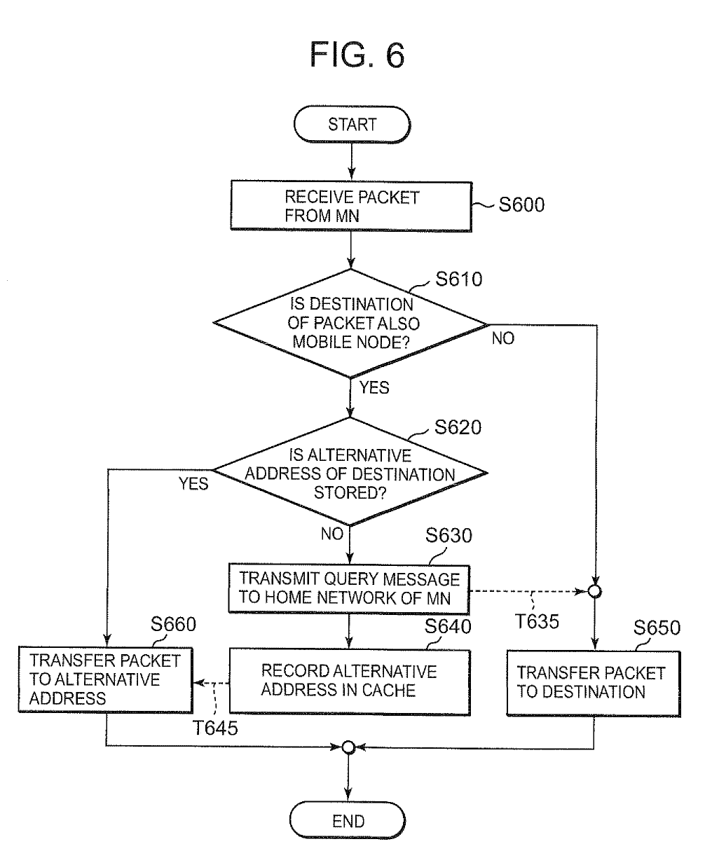

FIG. 6 is a diagram of a flowchart of an example of a method used by a proxy home agent within the overlay network to process a packet received from a mobile node within an access network managed by the proxy home agent.

After the proxy home agent receives the packet from the mobile node (Step S600), first, the proxy home agent checks whether the destination is a mobile node (Step S610). When the destination is not a mobile node, an ordinary transfer process (an ordinary packet transfer process using the overlay network, if required) is performed on the packet, as indicated at Step S650.

On the other hand, when the destination is a mobile node, at Step S620, the proxy home agent searches its own location cache 547 and checks whether an entry previously cached in relation to the actual position (or a suitable transfer destination) of the destination is present.

When a previously cached entry is present in the location cache 547, at Step S660, the packet is transferred to an address specified in the cache (an alternative address indicating a transfer destination of a packet destined for the mobile node).

On the other hand, when the previously cached entry is not present in the location cache 547, the proxy home agent proceeds to Step S630. At Step S630, the proxy home agent transmits a query message to the home network of the mobile node that is the destination of the packet to acquire an alternative address corresponding to the destination address of the packet.

Then, when a response message is received in response to the query message, at Step S640, the alternative address included in the response message is stored in the location cache 547. At Step S660, the packet is transferred to the alternative address.

Processing of the query message regarding the alternative address and the response message may require time, depending on the distance between the home agent of the mobile node that is the destination address of the packet and the proxy home agent making the query. For example, the process can be divided at Step S630 (transition T635), and the process can proceed to Step S650 from Step S630. In other words, while the ordinary packet transfer process is performed, the query message is transmitted and a response message waiting state is entered. In this instance, because the packet is already transmitted, a transition T645 from Step S640 to Step S660 is not required.

Moreover, because the destination address belongs to the home network, the packet (data packet) and the query message are transmitted along a same path. Therefore, the packet can be encapsulated in the query message.

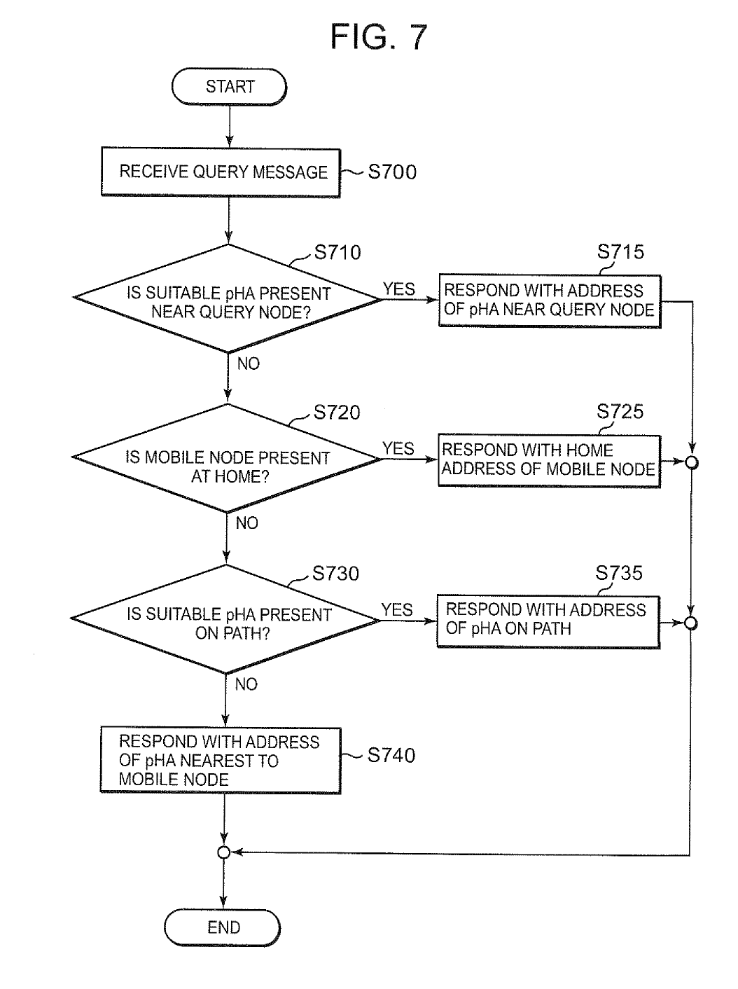

FIG. 7 is a diagram of a flowchart of an example of an algorithm used by the home agent within the overlay network to decide a response method for the query message related to the position of the mobile node.

When the home agent receives the query message at Step S700, at Step S710, the home agent checks whether a suitable proxy home agent positioned near the transmission source address of the query message is present within the overlay network. This process is actualized by, for example, examination of information managed by the proxy locator 545.

The suitable proxy home agent in this instance is required to be able to intercept the packet transferred from the query node (the transfer source node of the packet) without requiring measures related to ingress filtering and route setting. When the suitable proxy home agent is found, the process proceeds to Step S715. A response message including the address of the proxy home agent near the transmission source address of the query message is transmitted. The process at Step S715 corresponds to the operation according to the first embodiment of the present invention.

On the other hand, when a position of a proxy home agent near the query node cannot be identified, at Step S720, the home agent checks whether the mobile node is currently present at home (present in the home network).

When the mobile node is present in the home network, the process proceeds to Step S715. A response message including the home address of the mobile node is transmitted.

Here, whether the mobile node is present in the home network is checked (Step S720) after the presence of a suitable proxy home agent is checked (Step S710). However, the process at Step S720 can be performed before the process at Step S710. An advantage achieved as a result of the process at Step S720 being performed after the process at Step S710 is that, when the first embodiment of the present invention is applied, the privacy of the position is protected even when the mobile node is present at home. In other words, as a result of the process at Step S720 being performed after the process at Step S710, an external third party cannot determine whether the mobile node is currently present at home.

On the other hand, when the mobile node is not present at home, the process proceeds to Step S730. Whether a suitable proxy home agent present on the path (or near the path) from the query node to the actual position of the mobile node can be determined is checked. This process is actualized by, for example, a query being made to the proxy locator 545.

When a suitable proxy home agent is found at Step S730, the process proceeds to Step S735. A response message including the address of the found proxy home agent is transmitted. The process at Step S735 corresponds to the operation according to the third embodiment of the present invention.

On the other hand, when a proxy home agent such as this is not found at Step S730, the process proceeds to Step S740. A response message including an address of a proxy home agent in the overlay network nearest to the actual position of the mobile node that is the destination of the packet is transmitted. The process at Step S740 corresponds to the operation according to the second embodiment of the present invention.

The flowcharts shown in FIG. 6 and FIG. 7 are merely an example of the processes performed by the proxy home agent or the home agent. Other processing methods following the basic concept of the present invention can be performed.

The HA that receives the query regarding the transmission destination of the packet to actualize route optimization can decide the content (suitable transfer destination address) of the response by confirming the status of the mobile node managed by the HA itself.

For example, when the proxy home agent nearest to the mobile node is used as the transfer destination as described above, the amount of resources used in the overlay network can be suppressed. When the proxy home agent nearest to the query node is used as the transfer destination, the degree of protection of the privacy of the positions can be enhanced.

Therefore, the content of the response can be decided depending on whether the mobile node is receiving a service providing a certain added value (such as protection of privacy of its position). For example, when the mobile node desires protection of privacy of its position, the proxy home agent nearest to the query node is selected as the transfer destination.

On the other hand, regarding a mobile node that does not subscribe to a service proving protection of privacy of its position such as that described above, the proxy home agent closest to the mobile node is selected to minimize the amount of resources used in the overlay network.

In the present specification, the present invention is illustrated and described such that the most practical and preferable examples are given. However, the present invention is not limited to the above-described embodiments. For example, the present invention can be applied to an overlay network that provides route optimization support for both a mobile host and a mobile router. Moreover, according to the above-described embodiments, it is assumed that the overlay network has a global configuration. However, the present invention can also be applied to a local mobility management environment.

For example, proxy mobility IP (PMIP) that is a local mobility management method provides mobility support to a mobile terminal by a mobile access gateway (MAG) registering the movement of the mobile terminal to a local mobility anchor (LMA). The proxy home agent in the present specification can be applied to correspond to the MAG. In this instance, the home agent can be considered corresponding to the LMA.

In the present specification, the terms home agent and proxy home agent are used in the explanations. However, it is clear to a person skilled in the art that a relationship with the home agent and the proxy home agent of the mobile node (at an initial setting) is relative and changes over time. In other words, a home agent of a certain mobile node may become a proxy home agent of another mobile terminal. On the other hand, a situation may occur in which the proxy home agent of a certain mobile node is a home agent of another mobile node. Moreover, even regarding a same mobile node, a proxy home agent at a certain point may become the home agent and the node that is the home agent up to this point may become a proxy home agent after movement, setting changes, and the like.

Each functional block used in the explanations of the embodiment of the present invention, described above, can be actualized as a large scale integration (LSI) that is typically an integrated circuit. Each functional block can be individually formed into a single chip. Alternatively, some or all of the functional blocks can be included and formed into a single chip. Although referred to here as the LSI, depending on differences in integration, the integrated circuit can be referred to as the integrated circuit (IC), a system LSI, a super LSI, or an ultra LSI.

The method of forming the integrated circuit is not limited to LSI and can be actualized by a dedicated circuit or a general-purpose processor. A field programmable gate array (FPGA) that can be programmed or a reconfigurable processor of which connections and settings of the circuit cells within the LSI can be reconfigured can be used after LSI manufacturing.

Furthermore, if a technology for forming the integrated circuit that can replace LSI is introduced as a result of the advancement of semiconductor technology or a different derivative technology, the integration of the functional blocks can naturally be performed using the technology. For example, the application of biotechnology is a possibility.

### INDUSTRIAL APPLICABILITY

The present invention achieves an effect in which route optimization on a network base is actualized even when privacy-sensitive information, such as a position of a mobile node, is not revealed between two different networks. The present invention can be applied to a technical field related to an overlay network that abstracts a packet exchange type data communication network, such as an IP network.

1. An overlay network node belonging to an overlay network that is formed on top of a predetermined network and provides a global home agent overlay network service to a mobile node, in which the overlay network node includes a function related to the global home agent overlay network service, the overlay network node comprising:
a proxy home agent executing means that functions as a proxy home agent of the mobile node receiving the global home agent overlay network service;
a packet receiving means for receiving a packet transmitted from the mobile node managed by the proxy home agent executing means;
an address query means for making a query to a node managing an address of a node specified by a destination address of the packet regarding a current address of the node specified by the destination address of the packet;
an address acquiring means for acquiring an address of a node belonging to another global home agent overlay network as the current address of the node specified by the destination address of the packet, as a result of the query made by the address query means; and
a packet transferring means for transferring the packet to the address acquired by the address acquiring means.

2. The overlay network node according to claim 1, comprising:
a node judging means for judging whether the node specified by the destination address of the packet is a mobile node and, for instructing the address query means to make the query regarding the current address of the node when judging that the node specified by the destination address of the packet is a mobile node.

3. The overlay network node according to claim 1, comprising:
a node identifying means for identifying an overlay network node belonging to a same overlay network as the overlay network to which the subject overlay network node belongs, the identified overlay network node being present nearest to the node belonging to the other global home agent overlay network acquired by the address acquiring means,
wherein, the packet transferring means is arranged to tunnel the packet to the overlay network node identified by the node identifying means.

4. The overlay network node according to claim 1, comprising:
a query result storing means for storing a result of the query made by the address query means including the address of the node belonging to the other global home agent overlay network.

5. The overlay network node according to claim 4, comprising:
a cache-use controlling means for checking whether information corresponding to the destination address of the packet is stored in the query result storing means before the address query means makes the query and, when usable information is stored in the query result storing means, performing control to make the packet transferring means transfer the packet based on the information corresponding to the destination address of the packet stored in the query result storing means.

6. An overlay network node belonging to an overlay network that is formed on top of a predetermined network and provides a global home agent overlay network service to a mobile node, in which the overlay network node includes a function related to the global home agent overlay network service, the overlay network node comprising:
a home agent executing means for managing movement of the mobile node;
an address query receiving means for receiving a query regarding a current address of the mobile node of which the movement is managed by the home agent executing means, from a node belonging to another global home agent overlay network;
a node selecting means for selecting a node belonging to the overlay network providing the overlay network service to which the mobile node is subscribing, based on the query received by the address query receiving means; and
a query responding means for giving notification of an address of the node selected by the node selecting means as the current address of the mobile node in response to the query.

7. The overlay network node according to claim 6, wherein the node selecting means is arranged to select a node belonging to the overlay network providing the overlay network service to which the mobile node is subscribing that is set in a position nearest to the node transmitting the query.

8. The overlay network node according to claim 7, wherein the node selecting means is arranged to check whether a node belonging to the overlay network providing the overlay network service to which the mobile node is subscribing is present near the node transmitting the query.

9. The overlay network node according to claim 7, comprising:
a parameter notifying means for notifying the node transmitting the query of a parameter for setting a security association between the node selected by the node selecting means and the node transmitting the query.

10. The overlay network node according to claim 6, wherein the node selecting means is arranged to select a node belonging to the overlay network providing the overlay network service to which the mobile node is subscribing that is set in a position nearest to the mobile node.

11. The overlay network node according to claim 10, comprising:
a notifying means for notifying the node transmitting the query that the node selected by the node selecting means is no longer the node set in the position nearest to the mobile node, when a detection is made that the node selected by the node selecting means is no longer the node set in the position nearest to the mobile node.

12. The overlay network node according to claim 11, wherein, when the detection is made that the node selected by the node selecting means is no longer the node set in the position nearest to the mobile node, the node selecting means is arranged to re-select a node belonging to the overlay network providing the overlay network service to which the mobile node is subscribing that is set in a position nearest to the mobile node, and to notify the node transmitting the query of an address of the node newly selected by the node selecting means.

13. The overlay network node according to claim 6, wherein the node selecting means is arranged to select a node that is a node on a packet route between the node transmitting the query and the mobile node or a node positioned near the packet route, and that belongs to the overlay network providing the overlay network service to which the mobile node is subscribing.

14. The overlay network according to claim 6, wherein the node selecting means uses any one of methods in which:
the node selecting means selects a node belonging to the overlay network providing the overlay network service to which the mobile node is subscribing that is set in a position nearest to the node transmitting the query;
the node selecting means selects a node that is a node on a packet route between the node transmitting the query and the mobile node or a node positioned near the packet route, and that belongs to the overlay network providing the overlay network service to which the mobile node is subscribing; and
the node selecting means selects a node belonging to the overlay network providing the overlay network service to which the mobile node is subscribing that is set in a position nearest to the mobile node.

15. The overlay network node according to claim 6, wherein:
the node selecting means is arranged to select a node belonging to the overlay network providing the overlay network service to which the mobile node is subscribing that is set in a position nearest to the node transmitting the query,
when the node set in the position nearest to the node transmitting the query cannot be identified, select a node that is a node on a packet route between the node transmitting the query and the mobile node or a node positioned near the packet route, and that belongs to the overlay network providing the overlay network service to which the mobile node is subscribing, and
when the node on the packet route between the node transmitting the query and the mobile node or the node positioned near the packet route cannot be identified, select a node belonging to the overlay network providing the overlay network service to which the mobile node is subscribing that is set in a position nearest to the mobile node.
